(19) United States
(12) Patent Application Publication
(10) Pub. No.: US 2018/0215931 A1
(43) Pub. Date: Aug. 2, 2018

(54) ANTIMICROBIAL COATING COMPOSITION WITH IMPROVED YELLOWING RESISTANCE

(71) Applicants: Dow Global Technologies LLC, Midland, MI (US); Rohm and Haas Company, Collegeville, PA (US)

(72) Inventors: Junyu Chen, Shanghai (CN); Tao Wang, Shanghai (CN); Longlan Cui, Shanghai (CN); Tao Wang, Highton (AU)

(21) Appl. No.: 15/747,535

(22) PCT Filed: Aug. 13, 2015
(86) PCT No.: PCT/CN2015/086838

§ 371 Date: Jan. 25, 2018

(51) Int. Cl. C09D 5/14; C09D 7/61; C09D 7/65; C08K 3/08

(52) U.S. Cl. CPC C09D 5/14; C09D 7/61; C08L 25/04; C08K 3/08; C08K 2003/0806; C09D 7/65

(57) ABSTRACT

The present invention provides an antimicrobial coating composition comprising (i) a binder dispersion of (co)polymer particles and (ii) from 50 ppm to 2000 ppm, by dry weight based on total dry weight of the coating composition, a silver; wherein the binder dispersion comprises, as polymerized units, by dry weight based on total dry weight of the binder dispersion, (a) from 40% to 99.9% ethylenically unsaturated nonionic monomers and (b) from 0.1% to 60% phosphate group-containing (meth)acrylate monomers.

### FIELD OF THE INVENTION

The present invention relates to an antimicrobial coating composition with improved yellowing resistance.

### INTRODUCTION

Silver ion or silver element, when used in coating formulations, provide the coating formulations with excellent antimicrobial performance. The higher the silver content is in the coating, the better the antimicrobial performance is. However, when the silver content is at a concentration of higher than 100 ppm in the coating, the coating may turn yellow upon exposure to sunlight.

It is therefore desired in the coating industry to have an antimicrobial coating composition with high silver content and better yellowing resistance performance.

### SUMMARY OF THE INVENTION

The present invention provides an antimicrobial coating composition comprising (i) a binder dispersion of (co)polymer particles and (ii) from 50 ppm to 2000 ppm, by dry weight based on total dry weight of the coating composition, a silver; wherein the binder dispersion comprises, as polymerized units, by dry weight based on total dry weight of the binder dispersion, (a) from 40% to 99.9% ethylenically unsaturated nonionic monomers and (b) from 0.1% to 60% phosphate group-containing (meth)acrylate monomers.

### DETAILED DESCRIPTION OF THE INVENTION

The present invention provides an antimicrobial coating composition comprising (i) a binder dispersion of (co)polymer particles and (ii) from 50 ppm to 2000 ppm, preferably from 100 ppm to 1000 ppm, and more preferably from 200 ppm to 700 ppm, by dry weight based on total dry weight of the coating composition, a silver.

Binder Dispersion of (Co)Polymer Particles

The binder dispersion comprises, as polymerized units, by dry weight based on total dry weight of the binder dispersion, (a) from 40% to 99.9%, preferably from 60% to 99.7%, and more preferably from 75% to 99.5%, ethylenically unsaturated nonionic monomers; and (b) from 0.1% to 60%, preferably from 0.3% to 40%, and more preferably from 0.5% to 25%, phosphate group-containing (meth)acrylate monomers.

The mole ratio of the phosphate groups in the phosphate group-containing (meth)acrylate monomers to the silver is from 0.1 to 70, preferably from 0.3 to 50, and more preferably from 0.5 to 35.

The (co)polymer particles have a weight average molecular weight of from 400 to 500,000 Dalton, preferably from 500 to 300,000 Dalton, more preferably from 1,000 to 100,000 Dalton, even more preferably from 1,500 to 70,000 Dalton, and most preferably from 2,000 to 50,000 Dalton.

As used herein, the term “nonionic monomers” refers to monomers that do not bear an ionic charge between pH=1-14. Suitable examples of the ethylenic ally unsaturated nonionic monomers include alkyl esters of (methyl) acrylic acids such as methyl acrylate, ethyl acrylate, butyl acrylate, 2-ethylhexyl acrylate, decyl acrylate, lauryl acrylate, methyl methacrylate, butyl methacrylate, isodecyl methacrylate, lauryl methacrylate, hydroxyethyl methacrylate, hydroxypropyl methacrylate, and any combinations thereof; (meth)acrylonitrile; (meth)acrylamide; amino-functional and ureido-functional monomers such as hydroxyethyl ethylene urea methacrylate; monomers bearing acetoacetate-functional groups such as acetoacetoxyethyl methacrylate (AAEM); monomers bearing carbonyl-containing groups such as diacetone acrylamide (DAAM); ethylenically unsaturated monomers having a benzene ring such as styrene and substituted styrenes; butadiene; α-olefins such as ethylene, propylene, and 1-decene; vinyl acetate, vinyl butyrate, vinyl versatate and other vinyl esters; vinyl monomers such as vinyl chloride and vinylidene chloride; glycidyl (meth)acrylate; and any combinations thereof.

In a preferred embodiment, the ethylenically unsaturated nonionic monomer is selected from styrene, C₂-C₁₂ alkyl esters of (methyl) acrylic acids, derivatives thereof, and any combinations thereof.

Suitable examples of the phosphate group-containing (meth)acrylate monomers include phosphoalkyl (meth)acrylates such as phosphoethyl (meth)acrylate, phosphopropyl (meth)acrylate, phosphobutyl (meth)acrylate, salts thereof, and any combinations thereof; phosphoalkoxy (meth)acrylates such as phospho(ethylene glycol) (meth)acrylate, phospho(di-ethylene glycol) (meth)acrylate, phospho(tri-ethylene glycol) (meth)acrylate, phospho(propylene glycol) (meth)acrylate, phospho(di-propylene glycol) (meth)acrylate, phospho(tri-propylene glycol) (meth)acrylate, salts thereof, and any combinations thereof. The phosphate group-containing (meth)acrylate monomers preferably are selected from mono- or di-ester of phosphoalkyl (meth)acrylates, more preferably are mono- or di-ester of phosphoethyl methacrylate, and most preferably are phosphoethyl methacrylate (PEM).

Optionally, the binder dispersion further comprises, as polymerized units, by dry weight based on total dry weight of the binder dispersion, (c) from 0.01% to 30%, preferably from 0.1% to 20%, and more preferably from 0.3% to 10%, stabilizer monomers.

Suitable examples of the stabilizer monomers include sodium styrene sulfonate (SSS), sodium vinyl sulfonate (SVS), 2-acrylamido-2-methylpropanesulfonic acid (AMPS), acrylamide (AM), acrylic acid (AA), methylacrylic acid (MAA), itaconic acid (IA), and any combinations thereof.

The polymerization of the polymer particles can be any method known in the art, including emulsion polymerization, mini-emulsion polymerization, and mechanical dispersing technology.

Silver

In the present invention, silver is incorporated into the coating composition in silver element, i.e., Ag⁰, or in oxidation state silver ion, i.e., Ag¹⁺ and is provided in silver solutions. Suitable examples of the silver solutions include silver nitrate, silver acetate, silver citrate, silver iodide, silver lactate, silver picrate, silver sulfate in deionized (“DI”) water, and any combinations thereof. Preferred examples of the silver solutions are silver nitrate and silver iodide. Besides DI water, other liquid mediums can also be used, such as water, aqueous buffered solutions and organic solutions such as polyethers or alcohols. The concentration of the silver in these solutions can vary from the concentration required to add a known quantity of silver, i.e., from 50 ppm to 2000 ppm, preferably from 100 ppm to 1000 ppm, and more preferably from 200 ppm to 700 ppm, by dry weight based on total dry weight of the coating composition as in the present invention, to the antimicrobial coating composition to a saturated silver solution. Commercially available silver solutions include SILVADUR™ 900, SILVADUR 930, SILVADUR 961 and SILVADUR ET from The Dow Chemical Company, and IRGAGUARD™ B 5000, IRGAGUARD B 5120, IRGAGUARD B 6000, IRGAGUARD D 1071 and IRGAGUARD H 6000 from BASF Company.

The Antimicrobial Coating Composition

The coating composition may further comprise other pigments or extenders.

As used herein, the term “pigment” refers to a particulate inorganic material which is capable of materially contributing to the opacity or hiding capability of a coating. Pigments typically have a refractive index of equal to or greater than 1.8 and include zinc oxide, zinc sulfide, barium sulfate, and barium carbonate. For the purpose of clarity, titanium dioxide particles of the present invention are not included in the “pigment” of the present invention.

The term “extender” refers to a particulate inorganic materials having a refractive index of less than or equal to 1.8 and greater than 1.3 and include calcium carbonate, aluminium oxide (Al₂O₃), clay, calcium sulfate, aluminosilicate, silicate, zeolite, mica, diatomaceous earth, solid or hollow glass, and ceramic bead. The coating composition may optionally contain solid or hollow polymeric particles having a glass transition temperature (Tg) of greater than 60° C., such polymeric particles are classified as extenders for purposes of pigment volume concentration (PVC) calculations herein. The solid polymeric particles have particle sizes of from 1 to 50 microns, and preferably from 5 to 20 microns. A suitable example of the polymeric particles is ROPAQUE™ Ultra E opaque polymer commercially available from The Dow Chemical Company. For the purpose of clarity, the polymeric particles of the present invention are different from the first or the second polymer of the present invention. Calcium carbonate, clay, mica, and aluminium oxide (Al₂O₃) are preferred extenders.

PVC (pigment volume concentration) of the coating composition is calculated as follows,

PVC (%)=[volume of pigment(s)+volume of extender(s)]/total dry volume of coating.

In a preferred embodiment, the coating composition has a PVC of from 10% to 75%, and preferably from 20% to 70%.

Preparation of the Coating Composition

The preparation of the coating composition involves the process of selecting and admixing appropriate coating ingredients in the correct proportions to provide a coating with specific processing and handling properties, as well as a final dry coating film with the desired properties.

Application of the Coating Composition

The coating composition may be applied by conventional application methods such as brushing, roller application, and spraying methods such as air-atomized spray, air-assisted spray, airless spray, high volume low pressure spray, and air-assisted airless spray.

Suitable substrates for coating application include concrete, cement board, medium-density fiberboard (MDF) and particle board, gypsum board, wood, stone, metal, plastics, wall paper and textile, etc. Preferably, all the substrates are pre-primed by waterborne or solvent-borne primers.

### EXAMPLES

### I. Raw Materials

| Abbreviation | Chemical |
|---|---|
| BA | butyl acrylate |
| MMA | methyl methacrylate |
| (M)AA | (methyl) acrylic acid |
| AA | acrylic acid |
| SBS | sodium bisulfate |
| EDTA | ethylene diamine tetraacetic acid |
| t-BHP | tert-butyl hydroperoxide |
| MMP | 3-methylmercaptopropanal |
| BMA | butyl methacrylate |
| MAA | methacrylic acid |
| PEM | phosphoethyl methacrylate |
| IAA | isoascorbic acid |

| Chemical | Supplier |
|---|---|
| FOAMASTER ™ NXZ defoamer | BASF Company |
| NATROSOL ™ 250 HBR rheology modifier | Ashland Aqualon Company |
| AMP-95 ™ base | The Dow Chemical Company |
| OROTAN ™ 1288 dispersant | The Dow Chemical Company |
| TRITON ™ EF-106 wetting agent | The Dow Chemical Company |
| DISPONIL ™ FES 993 surfactant | BASF Company |
| ACRYSOL ™ RM-845 rheology modifier | The Dow Chemical Company |
| ACRYSOL ™ RM-2020 rheology modifier | The Dow Chemical Company |
| TI-PURE ™ R-706 TiO₂ | DuPont Company |
| TEXANOL ™ coalescent | Eastman Chemical Company |
| PRIMAL ™ AC-261p binder | The Dow Chemical Company |
| ROPAQUE ™ Ultra E opaque polymer | The Dow Chemical Company |
| CC-700 extender | Guangfu Building Materials Group (China) |
| DB-80 extender | Guangfu Building Materials Group (China) |
| propylene glycol | Sinopharm Chemical Reagent Co., Ltd. |
| SILVADUR ™ ET antimicrobial | The Dow Chemical Company |
| KATHON ™ LX 1.5% microbicide | The Dow Chemical Company |
| sodium hexametaphosphate | Sinopharm Chemical Reagent Co., Ltd. |
| RHODACAL ™ DS-4 anionic emulsifier | Solvay Chemical Company |
| SILQUEST ™ A-171 silane | Momentive Company |

### II. Test Procedures

1. Yellowing Resistance Determination

Coating drawdown was made with 200 um Bird film applicator on a cement board coated with primer, and then was allowed for 1-day drying in a CTR room. The dried coating films were placed beside the glass window for sun exposure. B values of the films were measured in two weeks by a BYK-Gardner color-guide sphere spectrophotometer. The smaller was B value change, the better was the yellowing resistance performance. And a B value change decrease bigger than 0.3 will be considered as a significant improvement.

### III. Experimental Examples

1. Preparation for Binder Dispersion 1

A monomer emulsion was prepared by mixing 386 g deionized water, 33.33 g (31% active) DISPONIL™ FES 993 surfactant, 650 g BMA, 150 g MAA, 206.4 g PEM, and 25.5 g MMP.

The reactor was a 5-liter four-neck round-bottom flask equipped with a paddle stirrer, a thermometer, a nitrogen inlet, and a reflux condenser. 706 g of deionized water and 33.33 g (31% active) DISPONIL™ FES 993 surfactant were added to the flask. The contents of the flask were heated to 85° C. under a nitrogen atmosphere and stirring. 43 g of the monomer emulsion was then added, quickly followed by a solution of 8 g sodium persulfate dissolved in 30 g deionized water, and a rinse of 5 g of deionized water. After stirring for 10 minutes, the remainder of the monomer emulsion, followed by a 30 g rinse, was added linearly over 120 minutes. An initiator and a buffer solution of 4.5 g sodium persulfate and 3.09 g sodium acetate dissolved in 180 g deionized water were started concurrent with the monomer emulsion feed and added linearly over a period of 125 minutes. When all additions were complete, the flask was diluted with 40 g deionized water and then cooled to 65° C. Three catalyst/activator pairs were added to the flask followed by promoter to reduce residual monomer. Then the flask was cooled down to 40° C., a biocide solution of 5.59 g of KATHON™ LX 1.5% in 20 g of deionized water was added over 10 minutes. After completion of the polymerization, the copolymer emulsion was cooled to ambient temperature and filtrated through a 325 mesh size screen.

2. Preparation for Binder Dispersion 2

Binder Dispersion 2 was prepared according to the above procedure by mixing deionized water, 128 g DISPONIL FES 993 surfactant (30% active), 648.84 g BA, 754.89 g MMA, 11.47 g PEM, 2.86 g MAA, and 10.45 g AA to prepare the monomer emulsion for Binder Dispersion 2.

3. Preparation for the Antimicrobial Coating Composition

Comparative Coating 1 (Comp.1) and Coatings 1 and 2 were prepared according to Table 1 using the following procedure. The grind ingredients were mixed using a high speed Cowles disperser. The let-down ingredients were added using a conventional lab mixer.

TABLE 1

| | | | |
|---|---|---|---|
| Materials | Comp. 1 | Coating 1 | Coating 2 |

Grind

| | | | |
|---|---|---|---|
| water | 200.0 | 200.0 | 200.0 |
| propylene glycol | 15.0 | 15.0 | 15.0 |
| TRITON ™ EF-106 wetting agent | 1.5 | 1.5 | 1.5 |
| FOAMASTER ™ NXZ defoamer | 1.0 | 1.0 | 1.0 |
| AMP-95 ™ base | 2.5 | 2.5 | 2.5 |
| OROTAN ™ 1288 dispersant | 3.0 | 3.0 | 3.0 |
| NATROSOL ™ 250 HBR | 3.0 | 3.0 | 3.0 |
| rheology modifier | | | |
| TI-PURE ™ R-706 TiO₂ | 180.0 | 180.0 | 180.0 |
| CC-700 extender | 80.0 | 80.0 | 80.0 |
| DB-80 extender | 30.0 | 30.0 | 30.0 |

Let down

| | | | |
|---|---|---|---|
| PRIMAL ™ AC-261p binder | 340.0 | 0.0 | 340.0 |
| Dispersion 2 | 0.0 | 358.0 | 0.0 |
| TEXANOL ™ coalescent | 20.0 | 20.0 | 20.0 |
| ROPAQUE ™ Ultra E opaque | 70.0 | 70.0 | 70.0 |
| polymer | | | |
| FOAMASTER ™ NXZ defoamer | 1.0 | 1.0 | 1.0 |
| ACRYSOL ™ RM-845 rheology | 2.5 | 2.5 | 2.5 |
| modifier | | | |
| ACRYSOL ™ RM-2020 rheology | 9.0 | 9.0 | 9.0 |
| modifier | | | |
| Dispersion 1 | 0.0 | 0.0 | 6.0 |
| SILVADUR ™ ET antimicrobial | 6.8 | 6.8 | 6.8 |
| water | 34.7 | 16.7 | 28.7 |
| Total | 1000.0 | 1000.0 | 1000.0 |

Comparative Coating 2 (Comp.2) and Coatings 3 and 4 were prepared with the same procedures of Table 1 with the main difference being the SILVADUR™ ET antimicrobial loading level as shown in Table 2. Coating 4 did not comprise either of the Binder Dispersions 1 and 2 prepared above, but it comprised sodium hexametaphosphate as an inorganic surfactant which was not polymerizable in the coating composition. Coating 4 comprised the sodium hexametaphosphate so that the mole ratio of phosphate group to silver is 28.8 in the coating composition.

### IV. Results

TABLE 2

| | | Mole ratio of | | |
|---|---|---|---|---|
| | | phosphate group to silver | | |
| | Silver | Polymerized | Inorganic | B values |
| Coatings | dosage* | phosphate group | phosphate group^{#} | change |
| Comp. 1 | 120 ppm | — | | 1.9 |
| Coating 1 | | 34.1 | | 1.4 |
| Coating 2 | | 13.5 | | 1.0 |
| Comp. 2 | 1300 ppm | — | | 3.5 |
| Coating 3 | | 0.6 | | 2.6 |
| Coating | | — | 28.8 | 3.5 |
| 4^{#} | | | | |

*by dry weight base on total dry weight of the coating composition; and
^{#}sodium hexametaphosphate (inorganic phosphate group) was added into the coating composition as an surfactant and was not polymerized onto the (co)polymer particles.

The results shown in Table 2 indicated that the binder composition comprising, as polymerized units, phosphate group-containing (meth)acrylate monomers improved yellowing resistance performance of silver containing antimicrobial coating composition.

At 120 ppm silver dosage, Coating 1 and Coating 2 compared to Comparative Coating 1, both showed reduced B value change, and indicated significantly improved yellowing resistance performance. At 1300 ppm silver dosage, Coating 3 compared to Comparative Coating 2, showed reduced B value change, and indicated significantly improved yellowing resistance performance Coating 4 comprised much higher mole of phosphate group compared to that of Coating 3 (28.8 compared to 0.8), but its yellowing resistance performance was not improved compared to that of Comparative Coating 2. Phosphate group played the role only when it was polymerized on the (co)polymer particles of the binder dispersion.

What is claimed is:

1. An antimicrobial coating composition comprising (i) a binder dispersion of (co)polymer particles and (ii) from 50 ppm to 2000 ppm, by dry weight based on total dry weight of the coating composition, a silver; wherein the binder dispersion comprises, as polymerized units, by dry weight based on total dry weight of the binder dispersion, (a) from 40% to 99.9% ethylenically unsaturated nonionic monomers and (b) from 0.1% to 60% phosphate group-containing (meth)acrylate monomers.

2. The antimicrobial coating composition according to claim 1 wherein the silver content is from 100 ppm to 1000 ppm, by dry weight based on total dry weight of the coating composition.

3. The antimicrobial coating composition according to claim 1 wherein the mole ratio of the phosphate groups in the phosphate group-containing (meth)acrylate monomers to the silver is from 0.1 to 70.

4. The antimicrobial coating composition according to claim 1 wherein the (co)polymer particles have a molecular weight of from 400 to 500,000 Dalton.

5. The antimicrobial coating composition according to claim 1 wherein the ethylenically unsaturated nonionic monomer is selected from styrene, C₂-C₁₂ alkyl esters of (methyl) acrylic acids, derivatives thereof, and any combinations thereof.

6. The antimicrobial coating composition according to claim 1 wherein the phosphate group-containing (meth)acrylate monomers are selected from mono- or di-ester of phosphoalkyl (meth)acrylates.

7. The antimicrobial coating composition according to claim 1 wherein the silver is incorporated into the coating composition in silver element, or in oxidation state silver ion as silver solutions.

8. The antimicrobial coating composition according to claim 6 wherein the silver solutions are selected from silver nitrate, silver acetate, silver citrate, silver iodide, silver lactate, silver picrate, silver sulfate in deionized water, and any combinations thereof.

9. The antimicrobial coating composition according to claim 1 wherein the coating composition has a pigment volume concentration of from 10% to 75%.
